(19) United States
(12) Patent Application Publication
(10) Pub. No.: US 2008/0285785 A1
(43) Pub. Date: Nov. 20, 2008

(54) Headphone/Earbud Cord Attachment

(76) Inventors: David Zieg, Littleton, CO (US); Ryan Stranahan, Littleton, CO (US)

Correspondence Address: Leyendecker & Lemire, LLC, C/O PORTFOLIO IP, P.O. BOX 52050, MINNEAPOLIS, MN, 55402, US

(21) Appl. No.: 11/748,921

(22) Filed: May 15, 2007

(51) Int. Cl. H04R 5/00

(52) U.S. Cl. 381/370

(57) ABSTRACT

A device comprising an ornamental object adapted to couple to a headphone/earbud cord along the length of the headphone/earbud cord. In one embodiment, the device is also adapted to be substantially stationary relative to the headphone/earbud cord.

### FIELD OF THE INVENTION

This invention generally relates to headphone/earbud cord attachments.

### BACKGROUND

“Headphones” are comprised of a pair of transducers placed in close proximity to a person's ears. The transducers receive an electrical signal from a media player or a receiver and use speakers to convert the signal into audible sound waves. The use of headphones began with the inventions of the telephone and radio, as sensitive headphones were about the only way to detect some of the weaker electrical signals produced by those early instruments.

Headphones are still in use today, being commonly known as earphones, earbuds, stereophones, headsets, or even by the slang term “cans”. Although cordless headphones/earbuds are presently in use, the great majority of headphones/earbuds in use today are wired headphones/earbuds, attaching to and receiving signals from media players and receivers through a jack plug. Players and receivers such as mobile phones, CD players, or mp3 players such as iPods®, among other devices, commonly use wired headphones/earbuds.

Often, headphones/earbuds are used in order to prevent other people from hearing the sound output from the media player or receiver. Headphone/earbuds may also produce a sound quality that is different than many other types of speakers. Wearing a pair of headphones/earbuds may also provide an ergonomic effect by allowing a wearer use of his or her hands while the person is wearing the headphones/earbuds.

Wearing headphones/earbuds not only provides a way for the user to hear the media they are listening to, it can also provide a “fashion statement” for the wearer. For instance, teenagers may attempt to display their rebellious nature by showing they are disconnecting from society through wearing headphones/earbuds. Likewise, wearing headphones/earbuds on public transportation systems may emit a statement such as “don't talk to me”. In these instances, and more, headphone wearers want others around them to associate that they are listening to, and are at least partially occupied by, something other than what is going on around them.

Unfortunately, there is a lack of items which enable headphone wearers to display in a more prominent manner the fact that the persons are wearing headphones/earbuds. Additionally, by simply wearing headphones/earbuds, the wearer is unable to convey to others around him what type of person the wearer is, and what the wearer may find important in life.

### SUMMARY OF THE DRAWINGS

FIG. 1 is a front view of a person wearing headphones/earbuds with a headphone cord attachment coupled to the headphone cord, the attachment resembling a football according to one embodiment of the invention.

FIG. 2 is a front view of a person wearing headphones/earbuds with a headphone cord attachment coupled to the headphone cord, the attachment resembling a flower according to one embodiment of the invention.

FIG. 3A is a side view of a headphone cord attachment resembling a football with a headphone cord reception portion in an open position according to one embodiment of the invention.

FIG. 3B is a side view of a headphone cord attachment resembling a football having a headphone cord reception portion comprising a slit in a closed position according to one embodiment of the invention.

FIG. 3C is a bottom view of a headphone cord attachment with a headphone cord reception portion comprising a slit according to one embodiment of the invention.

FIG. 4A is an isometric view of a headphone cord attachment resembling a flower according to one embodiment of the invention.

FIG. 4B is a cross-sectional view of a headphone cord attachment with a headphone cord reception portion comprising an opening having a first width and a cord reception cavity.

FIG. 5A is an isometric view of a female section of a headphone cord attachment showing a rear side cavity adapted to receive a male section having a trapezoidal cross-section.

FIG. 5B is a side view of a female section of a headphone cord attachment showing a dashed-line cavity according to one embodiment of the invention.

FIG. 5C is an isometric view of a male section of a headphone cord attachment having a trapezoidal cross-sectional geometry according to one embodiment of the invention.

FIG. 5D is a side view of a male section of a headphone cord attachment having a trapezoidal cross-sectional geometry according to one embodiment of the invention.

FIG. 5E is a bottom view of a headphone cord attachment with a male section having a trapezoidal cross-section inserted into the female sections according to one embodiment of the invention.

FIG. 6A is an isometric view of a headphone cord attachment with a cord reception cavity and a coupled horseshoe male section according to one embodiment of the invention.

FIG. 6B is an isometric view of a headphone cord attachment with a cord reception cavity and no coupled horseshoe male section according to one embodiment of the invention.

FIG. 6C is a side view of a headphone cord attachment with a cord reception cavity and a coupled horseshoe male section according to one embodiment of the invention.

FIG. 6D is an isometric view of a horseshoe male section according to one embodiment of the invention.

FIG. 7A is an isometric view of a headphone cord attachment with a cord reception cavity and a coupled rectangular male section according to one embodiment of the invention.

FIG. 7B is an isometric view of a headphone cord attachment with a cord reception cavity and no coupled rectangular male section according to one embodiment of the invention.

FIG. 7C is a side view of a headphone cord attachment with a cord reception cavity and a coupled rectangular male section according to one embodiment of the invention.

FIG. 7D is an isometric view of a rectangular male section according to one embodiment of the invention.

### DETAILED DESCRIPTION

One embodiment of the invention is an attachment to a headphone cord. One headphone cord attachment may be comprised of an ornamental object adapted to couple to a section of the headphone cord. An embodiment would allow a wearer of a pair of headphones or earbuds to display the ornamental object to others who are around the wearer. In one version, the attachment is substantially stable on the cord, sliding neither easily up and down the cord, nor easily rotating around the cord unless the wearer manually positions the attachment. By displaying to others an ornamental object the user may be able to inform others what that person feels is important in life.

A portion of one attachment may be comprised of a foam material, a polymeric resin, or another type of polymeric material such as, but not limited to an elastomeric material. Nonpolymeric headphone cord attachments, such as, but not limited to, metallic or jeweled attachments are also contemplated. Materials which may have elastic properties may also be used. One embodiment may be comprised of ethylene-vinyl acetate (EVA). A polymer such as EVA, or another material or materials may be used in one embodiment to provide qualities to the embodiment such as, but not limited to, limiting the weight of the device, as well as providing a low-cost material, thereby decreasing the cost of manufacture.

One version of an embodiment is comprised of a front side and a rear side, with one embodiment's front side comprising the ornamental object. One ornamental object may be a facsimile of a flower or a football. However, there essentially is no dearth to the type of objects that may comprise the ornamental object. The front side may also include one or more alphanumeric characters. Objects to display may be chosen based on their ability to allow the wearer to portray to others what that person finds important in life, or what type of personality that person has.

The rear side of an embodiment may be the portion of the attachment which allows the device to couple to a headphone cord. Other portions of one attachment may also couple to the cord. The rear side may have a headphone cord reception portion. One cord reception portion is adapted to couple the device to the headphone cord. An embodiment may also have a reception portion that is not coupled or integrated to the rear side.

One embodiment's rear side reception portion may be an opening. One type of opening may be a slit adapted to receive the headphone cord. Another reception portion version may be comprised of a female section and a male section. One female section may include the ornamental object and the male section may snappably engage with the female section.

One embodiment's female section comprises of the front side and a rear side portion with the male section snappably engaging to a cavity in the female section's rear side. An embodiment may be adapted to receive a headphone cord between the male section and the female section, with the device coupling to the headphone cord upon snapping the male section to the cavity.

One embodiment may also be comprised of a headphone cord channel. The channel may be adapted to correctly position the attachment on the headphone cord. Whether the headphone cord reception portion is an opening or whether the reception portion is comprised of a male section and a female section, both versions, as well as all other versions contemplated, allow the device to be coupled to the headphone in a manner where the device generally does not slide or rotate along the headphone cord unless designed or manually positioned to do so.

### Terminology:

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, tense or any singular or plural variations of the defined word or phrase.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of phrases like “in one embodiment”, “in an embodiment”, or “in a variation” in various places in the specification are not necessarily all meant to refer to the same embodiment or variation.

The term “couple” or “coupled” as used in this specification and the appended claims refers to either an indirect or direct connection between the identified elements, components or objects. Often the manner of the coupling will be related specifically to the manner in which the two coupled elements interact.

The term “integrate” or “integrated” as used in this specification and the appended claims refers to a blending, uniting, or incorporation of the identified elements, components or objects into a unified whole.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

As applicable, the terms “about” or “generally” as used herein unless otherwise indicated means a margin of ±20%. Also, as applicable, the term “substantially” as used herein unless otherwise indicated means a margin of ±10%. It is to be appreciated that not all uses of the above terms are quantifiable such that the referenced ranges can be applied.

The term “foam” or any variation thereof, as used in the specification and the appended claims refers to a material having a dispersion of gas or air bubbles therein, creating a lightweight cellular form.

### A First Embodiment of a Headphone Cord Attachment

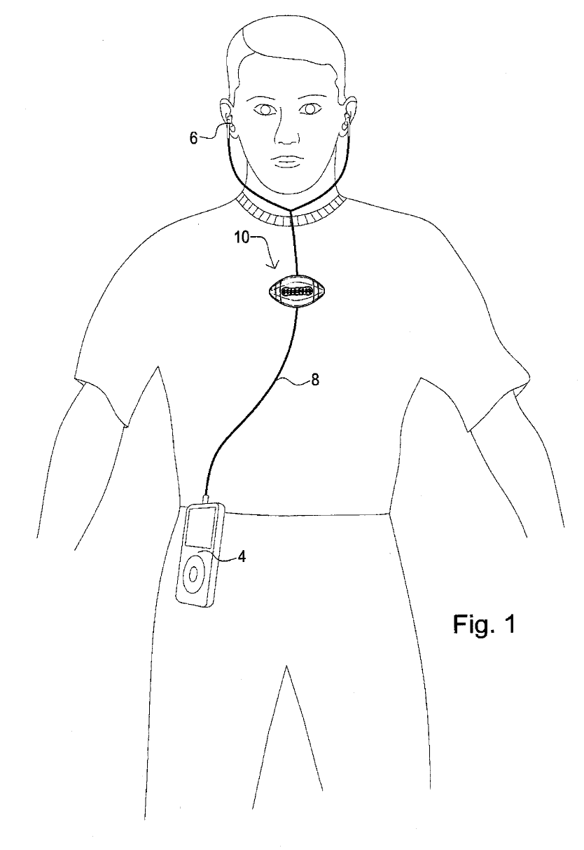

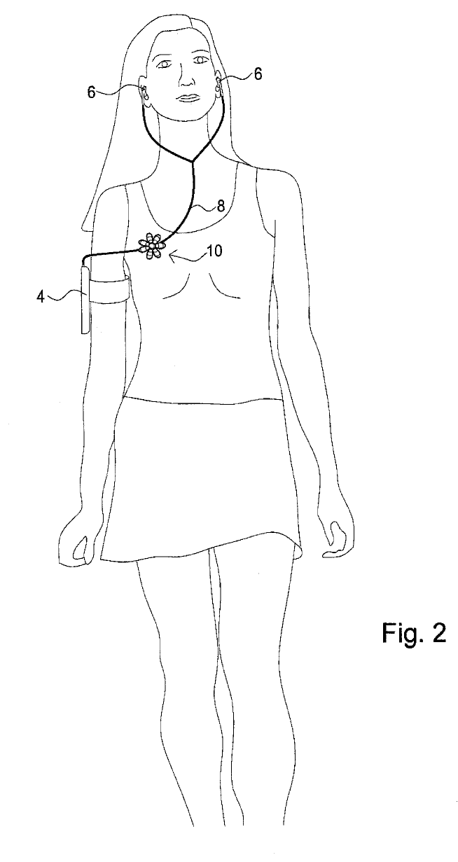

As best shown in FIGS. 1 through 4B, one embodiment of a headphone cord attachment 10 is comprised of an ornamental object. As best shown in FIGS. 1 and 2, one version of an attachment having an ornamental object may be comprised of a football or a flower, respectively. Other ornamental objects or artwork may be used. For example, a logo or picture may be printed, possibly through a screen printing process, on one attachment. Phrases comprising alphanumeric characters may be used as well in an attachment. One attachment is adapted to couple to the headphone cord 8. It is to be appreciated that the various sizes of the various attachments may vary relative to what is portrayed in the various figures.

One embodiment may couple to the cord 8 at a portion of the cord extending between a pair of earbuds 6 and a media player 4. An embodiment may have a headphone cord reception portion adapted to prevent the attachment 10 from sliding along the length of the cord or rotating about the cord. However, embodiments are contemplated that are adapted to rotate around the cord or slide up and down the cord. Multiple attachments may also couple to a single headphone cord. One headphone cord attachment may couple before or after the headphone cord splits to two cord portions, the end of each portion coupling to an earbud.

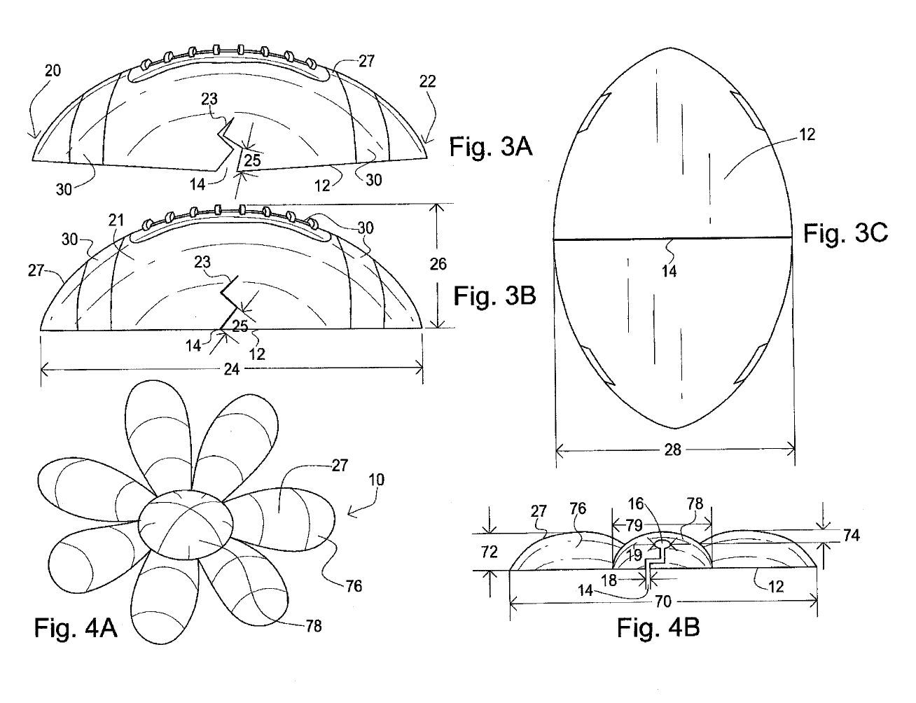

One embodiment's headphone cord reception portion is adapted to keep the attachment 10 substantially stable relative to the portion of the cord 8 that the attachment is coupled to. One headphone cord reception portion may comprise an opening 14 in an embodiment's rear side 12. FIGS. 3A through 4B display attachment versions with openings adapted to receive headphone cords. FIGS. 3A through 3C have openings that generally comprise a slit, where the slit may be a cut in the attachment's rear side, with 3A showing an open slit when flexed and 3B showing a closed slit. FIG. 4B generally shows an embodiment with an opening wider than a slit. The FIG. 4B opening may even have a cord reception cavity 16.

As best shown in FIG. 4B, in one embodiment having a cord reception cavity 16, the opening 14 has a first width 18. The first width may be the width of the opening where the opening intersects with the rear side 12. The cord reception cavity may have a second width 19. The second width may be larger than the first width in one embodiment and may be at a location other than the opening's intersection with the rear side. The first width may be generally less than the width of the headphone cord 8 and the second width may be generally equal to the headphone cord width. One embodiment's cord reception cavity may have a generally circular cross-section with a diameter about equal to the diameter of the headphone cord. The cavity diameter may also be the second width.

In one embodiment, the opening 14 enters into the interior of the device substantially perpendicularly from the rear side 12. The opening may then bend substantially perpendicularly to the original opening direction. The opening may then make a second bend, bending substantially parallelly to the opening's original direction. Other angles may be used in one variation. The cord reception cavity 16 may be located at the end of the opening, as best sown in FIG. 4B. Embodiments may also not be comprised of a cavity.

In one embodiment, the opening 14 extends through the attachment 10, dissecting opposing perimeters of the attachment, as best illustrated, for instance, in FIG. 3A. This enables the headphone cord 8 to be placed into the opening, rest in the cord reception cavity, and extend beyond the opposing perimeter sides to the earbuds and media player. One attachment's opening and cavity may have a coefficient of friction necessary to keep the attachment coupled to substantially the same portion of headphone cord as the attachment is worn by a wearer, as best shown in FIG. 1. Additionally, the coefficient of friction may not allow the attachment to rotate around the headphone cord.

Another version of an embodiment having an opening 14 is the slit version, as best shown in FIGS. 3A through 3C. In the slit version, the rear side 12 has a slit opening which works in a similar manner as the opening of FIGS. 4A and 4B. For example, the slit extends from one perimeter side to an opposing perimeter side, as best shown in FIG. 3C, to enable the headphone cord 8 to extend beyond each side of the attachment. Additionally, the friction created between the slit sides and the headphone cord keeps the attachment substantially stable relative to the cord in much the same manner as the opening/cavity version.

In one slit embodiment, the slit is a rear side 12 opening 14, generally extending inwardly and towards the front side 27 from an attachment centerline. The slit may be in a “zig-zag” shape. One zig-zag shape is a slit opening inwardly and non-perpendicularly relative to the rear side, creating an acute angle with the rear side. At a first distance 25, the slit may turn towards the attachment centerline. In one embodiment, the slit may make another turn generally so that the slit third portion is parallel with the slit direction of the first distance. The zig-zag shape may be used to keep attachment coupled to the cord and the cord from falling out of the opening.

One difference between a slit version and a non-slit version may be that the slit version is not comprised of a cord reception cavity 16. However, a slit version may be comprised of a headphone cord reception cavity in one embodiment as well. Another difference between a slit version and a non-slit opening version is that the slit opening width may be significantly less than the non-slit opening width. For example, when the attachment 10 is in a closed position, as best shown in FIG. 3B, the slit may have a negligible width, such that the sides of the slit are touching. In an open position, as best shown in FIG. 3A, the sides of the slit are pulled apart creating a wide opening. In one embodiment, the open position may be required in order to place the headphone cord into the slit. The open position may be created by folding a distal end 20 and a proximal end 22 toward each other. When the ends are released, one attachment is adapted to return the attachment into the closed position.

One attachment 10 is adapted to return to the closed position upon release of the ends of the embodiment because of the material the embodiment is made out of enables the embodiment to do so. For example, an embodiment may be comprised of ethylene-vinyl acetate, or “EVA” foam. Other polymeric materials having similar elastomeric properties such as, but not limited to, the softness and flexibility of EVA foam may also be employed. Some embodiments may even be comprised of material which may be polymeric, but may not have elastomeric properties. One material that may be used is a foam material such, but not limited to, polypropylene or closed cell foam. Generally, no matter the material used, the total weight of one particular embodiment is preferably less than 1 gram, more preferably less than 0.75 grams and most preferable less than 0.5 gram. Other weights may be necessary in certain applications. However, a low weight is preferable since a high attachment weight may pull on the cord, potentially causing the earbuds to fall out of the person's ear.

In one embodiment, the attachment 10 may be comprised of a plurality of layers. An embodiment's layers may be multi-colored. For example, as best shown in FIG. 3B, an embodiment first portion 21 may be a brown color. The embodiment first portion may have a foam second layer 30 of white on top of the first portion. The foam second layer may be inset into the embodiment first portion

Additionally, different sizes of embodiments are contemplated. For instance, one embodiment's length 24 may be about 1.5 inches, the width 28 may be about 1 inch, and the thickness 26 may be about 0.75 inches. Another embodiment may have a larger or smaller length, width, and thickness. One flower embodiment, as best shown in FIGS. 4A and 4B may have a diameter 70 of 1 inch. The maximum thickness 72 of an embodiment may be about 5/16 inches thick. The thickness of an embodiment where may be decreased by about ⅛ of an inch. For example, in one embodiment, where a flower petal 76 is integrated to a flower stigma 78. One flower embodiment's stigma may be about 5/16 inches wide. The front side 27 of one embodiment, and not necessarily a flower embodiment, may be a textured surface.

### A Second Embodiment of a Headphone Cord Attachment

As best shown in FIGS. 1, 2, and 5A through 7D, one embodiment of a headphone cord attachment 10 is comprised of a female section 40 and a male section 50. Similar to the first embodiment, both FIGS. 1 and 2 are representative of a user wearing the headphone cord attachment coupled to a headphone cord. The female section may have a rear side 12, a portion of which is adapted to receive the male section. One embodiment's rear side is a substantially planar surface. The rear side may have a headphone cord channel 42 or a rear side cavity 44. In one second embodiment version, the front side 27 is comprised of an ornamental object. The ornamental object may be the facsimile of an object such as, but not limited to, a football or a flower. Also, either the second embodiment or the first embodiment may not be comprised of an ornamental object. One second version embodiment may be adapted to create a more easily manufactured attachment than other attachment designs.

One embodiment is comprised of a headphone cord reception portion. The headphone cord reception portion may be comprised of the male section 50 and the female section 40. Another embodiment may have a headphone cord reception portion similar to a clip (not illustrated). The clip may also clip to a wearer's clothes. A headphone cord reception portion may also be comprised of the headphone cord channel 42. The headphone cord reception portion is adapted to couple the attachment to the headphone cord 8 and may be adapted to keep the attachment from rotating about the headphone cord.

One embodiment's female section 40 receives the headphone cord 8 in the headphone cord channel 42. A channel may intersect w/opposing sides of the rear side 12 perimeter and travel through a rear side cavity 44. The headphone cord may be placed in the channel and cavity. Upon placing the headphone cord in the channel, the male section may then be placed into and coupled to the cavity. One male section embodiment may be adapted to “snap” into the female section's rear side cavity. By securing the cord between the male section and the female section, the attachment may couple to the cord. Similarly, by placing the cord in one female section's headphone cord channel, an attachment may not rotate about the cord. One cord channel width may be about 1/16 inches wide.

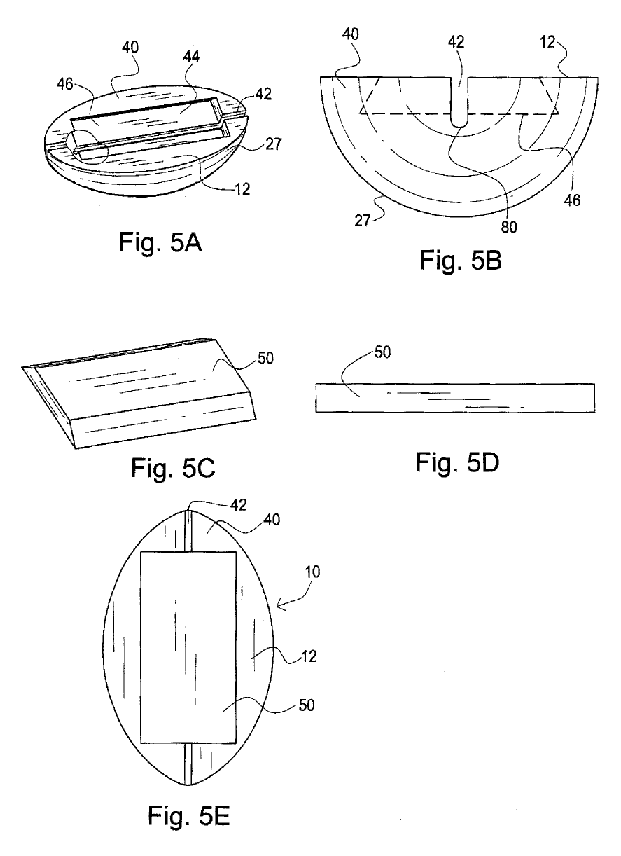

As best shown in FIGS. 5A through 5E, a cross-sectional area of the male section 50 may have a generally trapezoidal cross-section. Also, the cavity 44 on the rear side 40 of the female section 40 may have a trapezoidal cross-sectional area. The trapezoidal shape of one male section is adapted to enable the male section to couple to a female section rear side cavity, and be substantially stable therein when an attachment is coupled to a headphone cord. As described below, other cross-sectional area shapes are contemplated.

As best shown in FIG. 5A, the headphone cord channel 42 in one embodiment dissects opposing sides of the perimeter of the rear side 12 of the female section 40 and of the cavity 44. In the cut-away portion of FIG. 5A, and in the dashed-line of FIG. 5B, the channel can be seen as traveling below the bottom surface 46 of the cavity. In one embodiment, when the headphone cord 8 is placed in the channel, a portion of the headphone cord may rest on a channel bottom 80. (note: the headphone cord is best shown in FIGS. 1 and 2) and a portion of the headphone cord may stick above the cavity bottom surface 46.

When the male section 50 is coupled to the cavity 44, the headphone cord 8 may be pressed into the headphone cord channel bottom 80. As may be possible in a first embodiment, the cavity may not extend to the perimeter of the rear side and the bottom surface 46 may not extend through the front side 27. Opposingly, the headphone cord channel may extend out of the opposing ends of the cavity, dissecting opposing sides of the rear side 12 perimeter and integrated portions of the front side 27. This channel helps keep the attachment from rotating, although rotatably adapted versions are contemplated as well.

The material of one second embodiment is substantially similar to the material of one first embodiment. That is, one second embodiment may be comprised of polymeric material such as, but not limited to, EVA foam. Open cell foam use is also contemplated. Other non-foam polymeric materials may be used to comprise the male section 50 or the female section 40, respectively. For example, at least a portion of a female section may be comprised of foam and a portion of a male section may be comprised of synthetic rubber. Like the first embodiment, different colored layers of foam or other material may be used. In other embodiments, a design may be printed into or on top of the foam. Printed designs may be used in the first embodiment as well. Both the female or male sections may be manufactured by an injection molding process and may be comprised of a plurality of colors. Other manufacturing methods, such as, but not limited to, a stamping manufacturing process, heat molding or die cutting.

### A Third Embodiment of a Headphone Cord Attachment

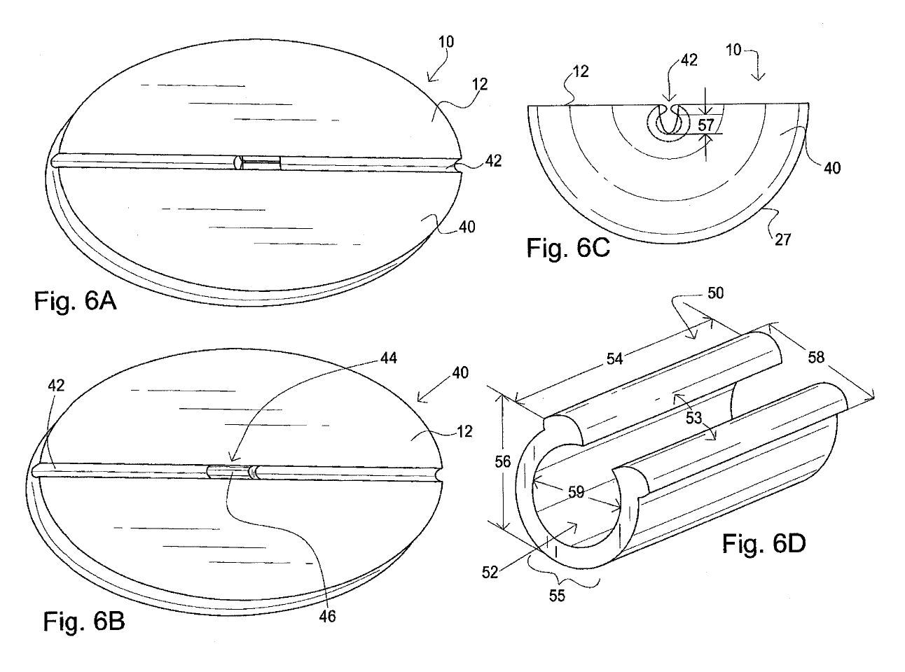

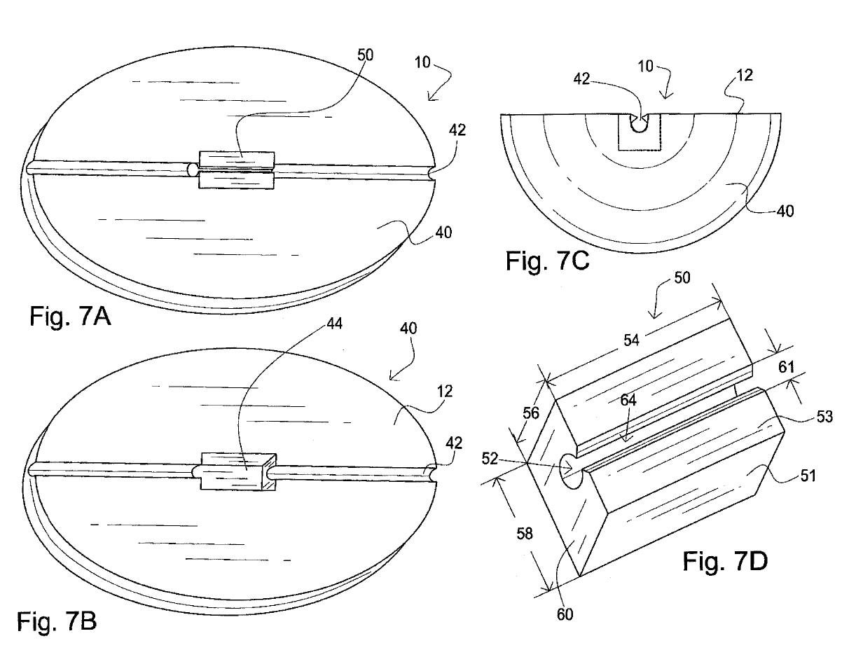

A third embodiment is shown in FIGS. 6A through 7D. One third embodiment version has a smaller cavity 44 on the rear side 12 of the female section 40, as best shown in FIG. 6B. Additionally, a cross-sectional area of the male section 50 is generally horseshoe shaped, as best shown in FIG. 6D. The overall shape of the male section may generally be comprised of a horseshoe shaped cylinder having a bore 52. The length 54 of a male section may only be 1/16 inches, the width of a male section may only be ⅛ inches, and the thickness of a male section may only be ⅛ inches. Other sizes are contemplated. There are similarities between the trapezoidal male section as shown in FIGS. 5A through 5D and the embodiment as shown in FIGS. 6A through 7D. For example, the headphone cord channel 42 may be generally similar between the two versions. Additionally, the shape and overall size of the two embodiments may be generally similar, and the female section's front side 27 may be similar.

One horseshoe-shaped third embodiment is adapted to couple to the headphone cord 8 in a manner different than the trapezoidal second embodiment. For example, one male section 50 bore 52 may be adapted to receive the headphone cord 8. Additionally, when the male section is coupled to the female section 40, a longitudinal axis of the bore may be substantially aligned with a longitudinal axis of the headphone cord channel 42. In one third embodiment, the male section bore may have a diameter 59 substantially equal to the diameter of the headphone cord. Other embodiments may have smaller diameters in order to the create a small tolerance between the headphone cord diameter and the diameter of the bore such that the male section adequately couples to the cord in a manner where the attachment neither slides nor rotates about the portion of the headphone cord the male section couples to.

The male section 50 may be comprised of rigid or semi-rigid synthetic rubber or another polymeric material and may be coupled to the female section by either “snapping” into place, or may be coupled to the female section through an adhesive. Other coupling mechanisms are contemplated and one male section may be integrated to the female section. The male section may snap into place by a person placing a male section bottom portion 55 on the cavity 44 and providing force to a top portion 53 of the male section such that the bottom portion is received into the cavity. One male section middle portion may bend inwardly towards bore center. One male section may be coupled or integrated to the female section during manufacturing.

As best shown in FIGS. 7A through 7D, a version of a third embodiment may be comprised of a female section 40 and a male section 50 having a generally rectangular cross-sectional area. Similar to the horseshoe version of the embodiment shown in FIGS. 6A through 6D, the cavity 44 on the rear side 12 of the female section may be a smaller cavity than the cavity shown in FIGS. 5A through 5E (where the male section has a trapezoidal cross-sectional area).

The rectangular male section 50 may be comprised of rigid or semi-rigid synthetic rubber or plastic in one embodiment and the female section may be comprised of closed-cell foam. Other materials may also be utilized. Like the horseshoe male section of FIG. 6D, the rectangular male section may also be comprised of the bore 52. The bore may be generally parallel with the one or more sides 51 of the male section and may be generally perpendicular to one or more ends 60 of the male section. Additionally, the bore may longitudinally align with the cord reception channel 42 in one embodiment.

One top portion 53 of a male section 50 has an opening 64 to receive a headphone cord 8. The length 61 of one embodiment's top portion opening intersection with the top portion may be about 1/16 inches wide. Additionally, one male section may have the length 54 as ¼ inches, the thickness 56 of ⅛ inches, and the width as 3/16 inches. The opening may be less than 1/16 inches wide and in one embodiment is 1/32 inches wide.

The rectangular male section 50 operates in substantially the same manner as the horseshoe male section. Therefore, the male section may couple to the cavity through an adhesive, although other coupling mechanisms, such as, but not limited to, a “screw-in” male section are contemplated. Additionally, the headphone cord 8 is coupled to the male section and placed in the headphone cord channel 42 in substantially the same manner as the horseshoe version.

### Other Embodiments and Variations

The embodiments of the headphone/earbud cord attachment and methods of use as illustrated in the accompanying figures and described above are merely exemplary and are not meant to limit the scope of the invention. It is to be appreciated that numerous variations to the invention have been contemplated as would be obvious to one of ordinary skill in the art with the benefit of this disclosure such as, but not limited to, a device having jewelry or light-emitting diodes.

I claim:

1) An ornamental headphone attachment adapted to (i) couple to a headphone/earbud cord along the length of the headphone/earbud cord, and (ii) be substantially stationary relative to the headphone/earbud cord.

2) The ornamental object of claim 1, further comprising
a polymeric foam material having:
a front side,
a rear side, and
a headphone cord reception portion adapted to couple the device to the headphone cord.

3) The ornamental object of claim 2 wherein,
the front side further comprising a skin; and
the foam material further comprising a plurality of foam layers.

4) The ornamental object of claim 2 wherein, the headphone cord reception portion comprising an opening in the polymeric foam material, the opening extending inwardly from the rear surface at least partially non-perpendicularly to the rear surface.

5) The ornamental object of claim 4 wherein, the opening comprises a slit, the slit: (i) having a zig-zag shape; and (ii) adapted to open and close to receive and release the headphone cord.

6) The ornamental object of claim 4 wherein, the opening further includes, (i) a first width no greater than the width of the headphone cord, and (ii) a second width, the second width being larger than the first width.

7) The ornamental object of claim 2 wherein,
the ornamental object further including a cord reception cavity;
the front side further comprising a facsimile of an object; and
the headphone cord reception portion is further adapted to keep the ornamental object from rotating relative to the headphone cord.

8) The ornamental object of claim 2 wherein,
the headphone cord reception portion comprising a female section and a male section, the male section snappably engagable with the female section; and
the device further comprising a headphone cord channel located in one of both of the male and female sections.

9) The ornamental object of claim 8 wherein,
the female section further comprising a rear side, the rear side having the headphone/earbud cord channel and a cavity extending inwardly from the rear side; and
the male section further adapted to couple and uncouple to the female section rear side;

10) The device of claim 8 wherein, the male section does not intersect a rear side perimeter.

11) The device of claim 9 wherein,
the male section further includes a male section headphone/earbud cord channel, the male section headphone/earbud cord channel correspondingly aligned with the female section headphone/earbud cord channel; and
the female headphone/earbud cord channel intersecting with a rear side perimeter.

12) The device of claim 8 wherein, the male section has a trapezoidal cross-section.

13) A combination comprising:
a headphone/earbud cord;
one or more ornamental objects coupled to the cord; and
a media emission source.

14) The combination of claim 13 wherein, the object further comprises:
a length less than 3 inches,
a width less than 3 inches, and
a thickness less than ¾ inch.

15) The combination of claim 13 wherein, the one or more ornamental objects comprises at least 3 ornamental objects.

16) A device comprising:
a female section, at least a portion of which comprises an ornamental object;
a male section removably engageable with the female section; and
wherein, the device is adapted to couple to a headphone/earbud cord.

17) The device of claim 16 wherein,
the ornamental object comprises a female section front side; and
the female section further comprising a female section back side, the back side having a back side cavity and a headphone/earbud cord trough.

18) The device of claim 17 wherein,
the male section is generally adapted to secure the headphone/earbud cord to the headphone/earbud cord trough; and
the device is further adapted to substantially stationary relative to the headphone/earbud cord portion coupled to the device.

19) The device of claim 16 wherein, the object further comprises at least one alphanumeric character.

20) The device of claim 16 further including a headphone/earbud cord reception portion.
